(19) United States
(12) Patent Application Publication
(10) Pub. No.: US 2026/0366938 A1
(43) Pub. Date: Nov. 19, 2026

(54) PRESSURE SENSOR AND METHOD FOR DETECTING AN ACCELERATION

(71) Applicant: Robert Bosch GmbH, Stuttgart (DE)

(72) Inventors: Elena Lisa Seyrich, Renningen (DE); Paul Fehling, Tuebingen (DE); Tamas Dogei, Nagykata (HU)

(21) Appl. No.: 19/673,131

(22) Filed: May 11, 2026

(30) Foreign Application Priority Data
May 14, 2025 (DE) 10 2025 118 473.9

(51) Int. Cl. G01L 9/00

(52) U.S. Cl. CPC G01L 9/0054; G01L 9/0073

(57) ABSTRACT

A pressure sensor for detecting a fluid pressure. A sensor device having a first measuring element, which is deflectable in a normal direction according to the fluid pressure while changing a first measured variable, and a second measuring element offset relative to the first measuring element, which second measuring element is deflectable in the normal direction while changing a second measured variable, wherein a mass arrangement is embodied in the normal direction above the sensor device, which mass arrangement has a spatial mass distribution in such a way that, in the case of at least one acceleration acting on the pressure sensor, a first acceleration force on the first measuring element, in each case arising due to the mass arrangement, differs from a second acceleration force on the second measuring element. A method for detecting an acceleration acting on the pressure sensor.

### CROSS REFERENCE

The present application claims the benefit under 35 U.S.C. § 119 of Germany Patent Application No. DE 10 2025 118 473.9 filed on May 14, 2025, which is expressly incorporated herein by reference in its entirety.

### FIELD

The present disclosure relates to a pressure sensor. Furthermore, the present disclosure relates to a method for detecting an acceleration acting on the pressure sensor.

### BACKGROUND INFORMATION

Germany Patent Application No. DE 10 2021 207 736 A1 describes a pressure sensor having two pressure sensor elements, in each case having a diaphragm, which have different stiffnesses relative to one another and are deflected differently at the same ambient pressure. The pressure measurement can be carried out in a first pressure range using both the first and the second pressure sensor element. In a second pressure range thereabove, the pressure measurement is carried out exclusively via the second pressure sensor element.

### SUMMARY

According to the present disclosure, a pressure sensor is provided. According to an example embodiment, the pressure sensor detects a fluid pressure and includes: a sensor device having a first measuring element, which is deflectable in a normal direction according to the fluid pressure while changing a first measured variable, and a second measuring element offset relative to the first measuring element, which second measuring element is deflectable in the normal direction while changing a second measured variable, wherein a mass arrangement is embodied in the normal direction above the sensor device, which mass arrangement has a spatial mass distribution in such a way that, in the case of at least one acceleration acting on the pressure sensor, a first acceleration force on the first measuring element, in each case arising due to the mass arrangement, differs from a second acceleration force on the second measuring element.

As a result, the pressure sensor can also be usable for detecting acting accelerations. The pressure sensor can measure the fluid pressure more accurately and more reliably. An acceleration cross-sensitivity of the pressure sensor can be compensated for more accurately and more quickly. A separate acceleration sensor can be omitted, or a separate acceleration sensor can be calibrated (checked).

The pressure sensor can be a microelectromechanical (MEMS) pressure sensor. The pressure sensor can be usable in a vehicle, an aircraft, a watercraft, an industrial product, a healthcare product, a medical product and/or a mobile device (a smartphone, a smartwatch).

The first measuring element can have at least one deflectable diaphragm. The diaphragm can be deflectable according to the fluid pressure (and the acting acceleration). The first measuring element can have a piezoresistive and/or capacitive measuring principle for measuring the deflection.

The second measuring element can have at least one deflectable diaphragm. The second measuring element (the diaphragm) can be deflectable according to the fluid pressure (and the acting acceleration). The second measuring element can have a piezoresistive and/or capacitive measuring principle for measuring the deflection.

The sensor device can have a measuring bridge circuit (a full-bridge circuit, a half-bridge circuit) for detecting the first and the second measured variable. The sensor device can measure the fluid pressure at least via the first and the second measured variable. The detection of the fluid pressure can be a measurement of the fluid pressure (at least via the first and the second measured variable).

The fluid pressure can be an absolute pressure (an air pressure, an ambient pressure of the sensor environment) and/or a differential pressure (between a front side and a rear side of the sensor device).

The first and/or the second measured variable can be an electrical measured variable (a resistance, a current, a voltage, a capacitance, an inductance). The first and/or the second measured variable can be present as an analog and/or electrical measuring signal.

The acting acceleration can be a gravitational acceleration and/or a linear and/or rotational acceleration.

The pressure sensor can have a housing. The sensor device can be arranged in the housing.

The first and the second measuring element can have the same (different) surface dimensions, the same density (different densities, an average density), and/or the same thickness (different thicknesses, an average thickness) (in the normal direction). The first and the second measuring element can be constructed from the same material (materials differing from one another).

The sensor device can have at least one further measuring element, which, in the case of the acting acceleration, is deflectable in the normal direction while changing a further measured variable.

In a preferred example embodiment of the present disclosure, it is advantageous if the first and the second measuring element are arranged offset relative to one another in a lateral direction perpendicular to the normal direction. The first and the second measuring element can be arranged at the same height (at different heights) in relation to the normal direction.

A preferred configuration of the present disclosure is advantageous in which the first and the second measuring element are arranged in such a way that a fluid pressure applied to the pressure sensor is the same at the first and the second measuring element. The first and the second measuring element can both be arranged facing the sensor environment.

In a preferred embodiment of the present disclosure, the mass arrangement comprises a first mass distribution in the normal direction above the first measuring element and a second mass distribution in the normal direction above the second measuring element. The mass arrangement can comprise a first mass in the normal direction above the first measuring element and no mass in the normal direction above the second measuring element or vice versa. The first mass distribution can differ from the second mass distribution.

In an advantageous embodiment of the present disclosure, the mass arrangement is a continuous mass composite in the normal direction above the first and the second measuring element. The mass composite can have a different (spatially variable) height and/or density in the normal direction above the first measuring element and the second measuring element. The mass composite can have an (average) height and/or density in the normal direction above the first measuring element and a different (average) height and/or density in the normal direction above the second measuring element. The height can be a layer thickness of the mass composite.

In a preferred embodiment of the present disclosure, it is advantageous if the mass composite is an encapsulation compound for protecting the sensor device from environmental influences. The pressure sensor can be designed to be media-robust.

The encapsulation compound can be a protective gel (a silicone gel, a PFAS-containing gel, a PFAS-free gel) and/or an oil (a silicone oil, a fluorinated oil). The encapsulation compound can delimit (seal) the sensor device with respect to the sensor environment. The encapsulation compound can be viscoelastic and/or highly viscous. The encapsulation compound can protect the sensor device from moisture, water, dirt and/or particles from the sensor environment. The encapsulation compound can be constructed from an electrically insulating material. The encapsulation compound can be arranged mainly (exclusively) for protecting (for insulating) the sensor device from environmental influences from the sensor environment. The encapsulation compound can transmit the fluid pressure of the sensor environment to the sensor device. The sensor device can be received by the encapsulation compound in a watertight manner with respect to the sensor environment. The encapsulation compound can adjoin the sensor environment at the surface side on a side opposite the sensor device. The encapsulation compound can cover the entire sensor device.

The mass composite (the encapsulation compound) can be arranged in the housing. The mass composite (the encapsulation compound) can extend as far as a housing edge of the housing. The housing can have an opening facing the sensor environment of the pressure sensor, for pressure transmission of the fluid pressure between the sensor environment of the pressure sensor and the sensor device.

In an advantageous embodiment of the present disclosure, the first measuring element is designed for detecting an applied fluid pressure in a first pressure range and the second measuring element is designed for detecting an applied fluid pressure in a second pressure sensor, and the first pressure range differs from the second pressure range. In deviation therefrom, the first and the second pressure range can be the same. The first and the second pressure range can be spaced apart from one another, directly adjoin one another or overlap relative to one another.

A preferred configuration of the present disclosure is advantageous in which the first measuring element is deflectable while changing the first measured variable according to the first acceleration force, and the second measuring element is deflectable while changing the second measured variable according to the second acceleration force. The first and/or the second measuring element (the deflection) can have an acceleration cross-sensitivity. The acceleration cross-sensitivity can be a cross-sensitivity of the pressure sensor (of the sensor device, of the first measuring element, of the second measuring element) with respect to the acting acceleration. The first and/or the second measured variable can be influenceable (changeable) by the acting acceleration because of the acceleration cross-sensitivity.

The effects of the acceleration cross-sensitivity (on the sensor device, the first measuring element, the second measuring element) can depend on the mass arrangement. The acting acceleration can correspond to an equivalent pressure because of the acceleration cross-sensitivity, which equivalent pressure influences the first and/or the second measured variable like a fluid pressure (at the first and the second measuring element).

According to the first and the second measured variable which are changeable by the first and the second acceleration force, the acting acceleration can be detectable. The detected acting acceleration can be usable for compensating for an acceleration cross-sensitivity on the first and the second measured variable and thus on the detection of the fluid pressure.

The sensor device can detect the fluid pressure and the acting acceleration (using the first and the second measuring element). The first and the second measured variable can depend on the fluid pressure and, via the mass arrangement, on the acting acceleration.

According to the present disclosure, a method for detecting is further proposed. Due to the different first and second acceleration forces, the first measured variable can differ from the second measured variable even at the same fluid pressure at the first and the second measuring element. This acceleration-related difference between the first and the second measured variable caused by the mass arrangement can form the measurement difference, via which the acting acceleration can be detected.

The method for detecting can be carried out in a computing unit. The computing unit (ASIC) can be arranged in (outside) the pressure sensor (a sensor hub comprising a plurality of pressure sensors).

The method for detecting can be initiated continuously (in a free-running mode), upon a system start (a start of the pressure sensor), upon spike recognition (outlier recognition) in the first and/or the second measured variable (in the acceleration signal, in the pressure signal), in particular according to a comparison (a verification) with past data of the pressure sensor (which are temporarily stored in a memory), by a (situational, pressure-dependent, acceleration-dependent) trigger and/or by a user input (a user prompt, manually).

The method for detecting can implement (qualitative) acceleration recognition (motion recognition), fall recognition (by a combination of full-bridge measurement data and half-bridge measurement data), a (quantitative) acceleration measurement, a self-calibration (a self-test) of the pressure sensor and/or a functional test (of an external acceleration sensor).

In an advantageous embodiment of the present disclosure, according to a comparison between the detected measurement difference and a threshold value, at least an acting acceleration is inferred. If the measurement difference exceeds the threshold value, an existing acting acceleration can be inferred.

According to the measurement difference (the magnitude, the sign), the acceleration variable (a magnitude, a direction) of the acting acceleration can be calculated. The acceleration variable can be calculated according to a previously known assignment relationship between the measurement difference and the acceleration variable (the magnitude, the direction) by inputting the measurement difference. The assignment relationship can have been ascertained in advance (on the basis of acceleration variables of known accelerations).

Furthermore, a method for compensating for a pressure variable of a pressure sensor is provided. According to an example embodiment, the method for compensating comprises the steps of the method for detecting the acceleration and further comprises calculating a pressure measured variable specifying the fluid pressure, at least according to the first and the second measured variable. Furthermore, the pressure measured variable is compensated for by a signal influence (an acceleration-related signal offset, an equivalent pressure) corresponding to the detected acceleration variable.

The features in parentheses in the preceding and following description, optionally comma-separated and therefore to be understood individually or in combination with one another, are to be understood as alternative, optional, supplementary, limiting, clarifying, exemplary, expanding, abbreviating and/or explanatory specifications regarding the feature(s) immediately preceding and/or following the respective parentheses.

Further advantages and advantageous configurations of the present disclosure can be found in the description of the figures.

### BRIEF DESCRIPTION OF THE DRAWINGS

The present disclosure is described in detail below with reference to the figures.

FIGS. 1-3 in each case show a cross section of a pressure sensor in a specific example embodiment of the present disclosure.

FIG. 4 is a plan view of a pressure sensor in a further specific example embodiment of the present disclosure.

FIG. 5 shows a method for detecting an acceleration in a specific example embodiment of the present disclosure.

### DETAILED DESCRIPTION OF EXAMPLE EMBODIMENTS

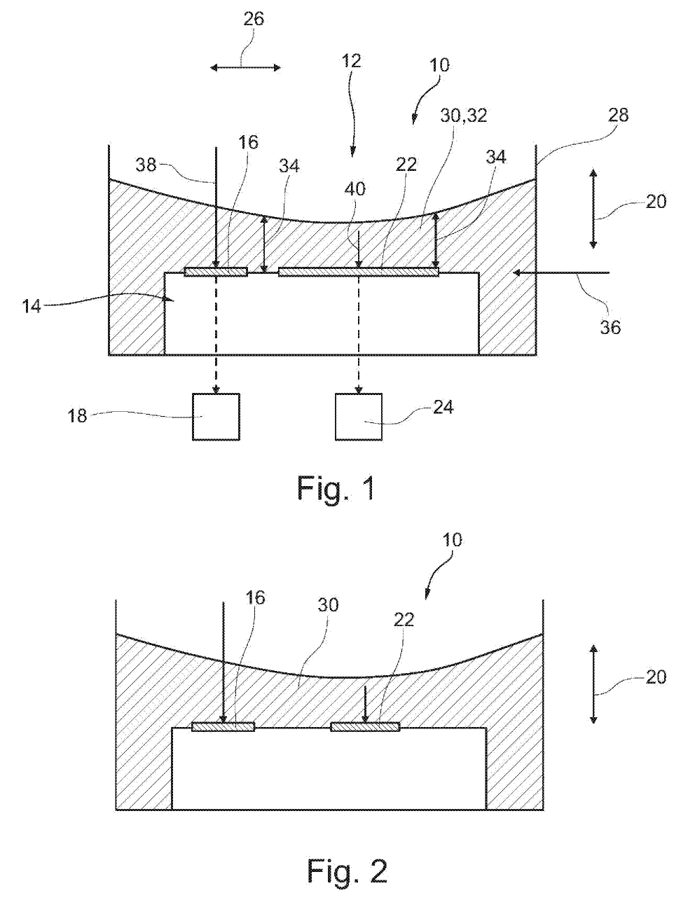

FIGS. 1-3 in each case show a cross section of a pressure sensor in a specific embodiment of the present disclosure. The pressure sensor 10 in FIG. 1 for detecting a fluid pressure, in particular in a sensor environment 12 of the pressure sensor 10, comprises a sensor device 14 having a first measuring element 16, which is deflectable in a normal direction 20 according to the fluid pressure while changing a first measured variable 18, and a second measuring element 22 offset relative to the first measuring element 16, which second measuring element is deflectable in the normal direction 20 while changing a second measured variable 24. The first and the second measuring element 16, 22 are arranged offset relative to one another in a lateral direction 26 perpendicular to the normal direction 20.

The first and the second measuring element 16, 22 are arranged in such a way that a fluid pressure (an air pressure) applied to the pressure sensor 10 is the same at the first and the second measuring element 16, 22. The first measuring element 16 has smaller surface dimensions than the second measuring element 22. The first measuring element 16 is designed for detecting an applied fluid pressure in a first pressure range and the second measuring element 22 is designed for detecting an applied fluid pressure in a second pressure range, wherein the first pressure range differs, for example, from the second pressure range.

The sensor device 14 is received in a housing 28. A mass arrangement 30 is embodied in the normal direction 20 above the sensor device 14. The mass arrangement 30 is embodied as a continuous mass composite 32, which has a different layer thickness 34 (a different height) and, as an encapsulation compound, provides protection of the sensor device 14 from environmental influences from the sensor environment 12.

The mass arrangement 30 has a spatial mass distribution in such a way that, in the case of an acceleration 36 acting on the pressure sensor 10, a first acceleration force 38 on the first measuring element 16, in each case arising due to the mass arrangement 30, differs from a second acceleration force 40 on the second measuring element 22. For example, an average layer thickness 34 of the mass composite 32 in the normal direction 20 above the first measuring element 16 is greater than an average layer thickness 34 of the mass composite 32 in the normal direction 20 above the second measuring element 22. Thus, the mass composite 32 forms a first mass distribution in the normal direction 20 above the first measuring element 16 and a second mass distribution, different from the first mass distribution, above the second measuring element 22.

The first measuring element 16 is deflectable while changing the first measured variable 18 according to the first acceleration force 38, and the second measuring element 22 is deflectable while changing the second measured variable 24 according to the second acceleration force 40. The first and the second acceleration forces 38, 40 differ from one another because of the different first and second mass distributions, and thus a measurement difference is present between the first and the second measured variable 18, 24 in the case of an acting acceleration 36.

The pressure sensor 10 in FIG. 2 is similar to that of FIG. 1 except for the following differences. The surface dimensions of the first and the second measuring element 16, 22 are the same. The first and the second measuring element 16, 22 are arranged asymmetrically in relation to the mass arrangement 30. As a result, in the normal direction 20 above the first measuring element 16, the first mass distribution differs from the second mass distribution.

The pressure sensor 10 in FIG. 3 is similar to that of FIG. 1 except for the following differences. The first and the second measuring element 16, 22 are arranged symmetrically in relation to the mass arrangement 30. However, due to the acceleration 36 acting at an angle with respect to the normal direction 20, here perpendicularly, and the mass arrangement 30, the first acceleration force 38 acting on the first measuring element 16 is different from the second acceleration force 40 acting on the second measuring element 22.

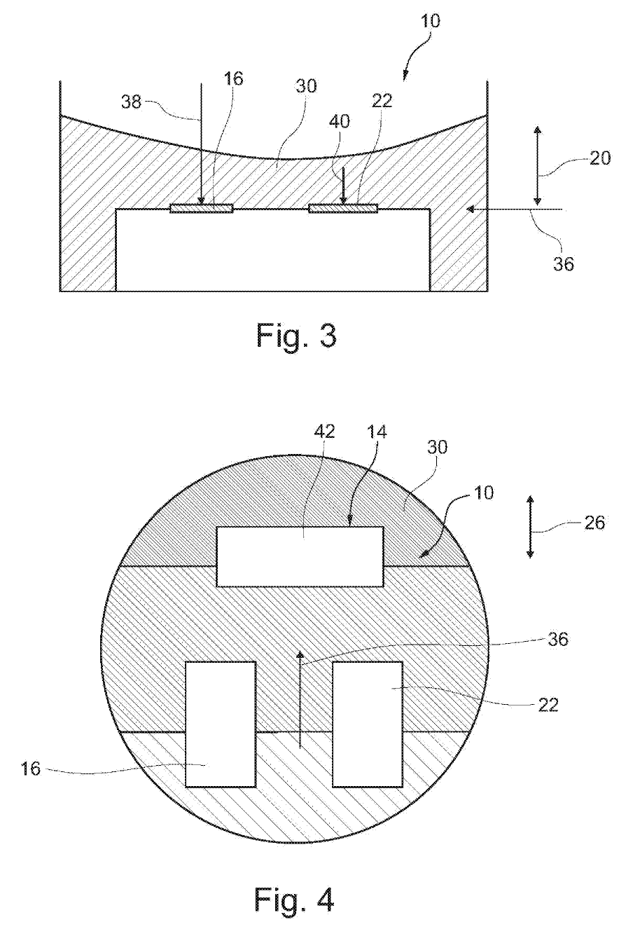

FIG. 4 is a top view of a pressure sensor in a further specific embodiment of the present disclosure. The pressure sensor 10 comprises the sensor device 14 having the first and the second measuring element 16, 22 and a further measuring element 42. The equivalent pressure arising due to the acting acceleration 36, which acts in the lateral direction 26, due to the mass arrangement 30 on the sensor device 14 (indicated via the differently hatched regions) is greater at the further measuring element 42, whereby a higher equivalent pressure is applied to the further measuring element 42 than to the first and the second measuring element 16, 22.

Due to the total of three measuring elements and the three measured variables detected thereby, which depend on the particular acceleration-related equivalent pressure, the magnitude and the direction (in Cartesian coordinates) of the acting acceleration 36 can be detected.

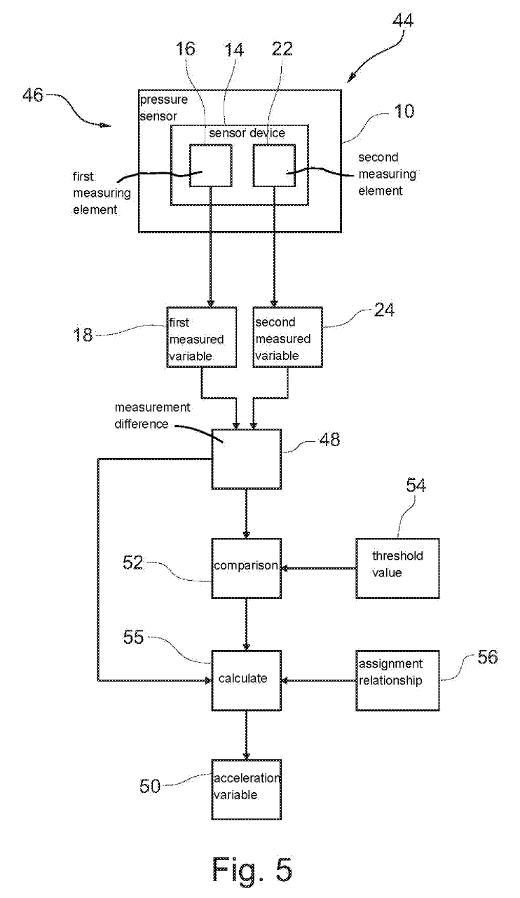

FIG. 5 shows a method for detecting an acceleration in a specific embodiment of the present disclosure. The method for detecting 44 an acceleration acting on the pressure sensor 10 comprises providing 46 a pressure sensor 10 having the sensor device 14 comprising at least the first and the second measuring element 16, 22, for example as shown in FIG. 1, wherein the first measuring element 16 is deflectable while changing the first measured variable 18 according to the first acceleration force, and the second measuring element 22 is deflectable while changing the second measured variable 24 according to the second acceleration force. After detecting the first and the second measured variable 18, 24, a measurement difference 48 between the first and the second measured variable 18, 24 is detected.

According to a comparison 52 between the detected measurement difference 48 and a threshold value 54, an acting acceleration is inferred. If the measurement difference 48 exceeds the threshold value 54, an existing acting acceleration can be inferred. Then, an acceleration variable 50, for example a magnitude and a direction of the acting acceleration, is calculated according to the measurement difference 48. The acceleration variable 50 can, for example, be calculated by calculating 55 according to a previously known assignment relationship 56 between the measurement difference 48 and the acceleration variable 50 (the magnitude, the direction) by inputting the measurement difference 48. The assignment relationship 56 can have been ascertained in advance on the basis of acceleration variables of known accelerations.

What is claimed is:

1. A pressure sensor for detecting a fluid pressure, comprising:
a sensor device including a first measuring element, which is deflectable in a normal direction according to the fluid pressure while changing a first measured variable, and a second measuring element offset relative to the first measuring element, the second measuring element being deflectable in the normal direction while changing a second measured variable; and
a mass arrangement arranged in the normal direction above the sensor device, the mass arrangement having a spatial mass distribution in such a way that, in a case of at least one acceleration acting on the pressure sensor, a first acceleration force on the first measuring element arising due to the mass arrangement differs from a second acceleration force on the second measuring element.

2. The pressure sensor according to claim 1, wherein the first measuring element and the second measuring element are arranged offset relative to one another in a lateral direction perpendicular to the normal direction.

3. The pressure sensor according to claim 1, wherein the first measuring element and the second measuring element are arranged in such a way that a fluid pressure applied to the pressure sensor is the same at the first measuring element and the second measuring element.

4. The pressure sensor according to claim 1, wherein the mass arrangement includes a first mass distribution in the normal direction above the first measuring element and a second mass distribution in the normal direction above the second measuring element.

5. The pressure sensor according to claim 1, wherein the mass arrangement is a continuous mass composite in the normal direction above the first measuring element and the second measuring element.

6. The pressure sensor according to claim 5, wherein the mass composite is an encapsulation compound for protecting the sensor device from environmental influences.

7. The pressure sensor according to claim 1, wherein the first measuring element is configured to detect an applied fluid pressure in a first pressure range and the second measuring element is configured to detect an applied fluid pressure in a second pressure range, and the first pressure range differs from the second pressure range.

8. The pressure sensor according to claim 1, wherein the first measuring element is deflectable while changing the first measured variable according to the first acceleration force, and the second measuring element is deflectable while changing the second measured variable according to the second acceleration force.

9. A method for detecting an acceleration acting on a pressure sensor, comprising the following steps:
providing a pressure sensor configured to detect a fluid pressure, including:
a sensor device including a first measuring element, which is deflectable in a normal direction according to the fluid pressure while changing a first measured variable, and a second measuring element offset relative to the first measuring element, the second measuring element being deflectable in the normal direction while changing a second measured variable, and
a mass arrangement arranged in the normal direction above the sensor device, the mass arrangement having a spatial mass distribution in such a way that, in a case of at least one acceleration acting on the pressure sensor, a first acceleration force on the first measuring element arising due to the mass arrangement differs from a second acceleration force on the second measuring element;
wherein the first measuring element is deflectable while changing the first measured variable according to the first acceleration force, and the second measuring element is deflectable while changing the second measured variable according to the second acceleration force;
detecting the first measured variable and the second measured variable;
detecting a measurement difference between the first measured variable and the second measured variable; and
detecting an acceleration variable of the acceleration acting on the pressure sensor according to the measurement difference.

10. The method for detecting according to claim 9, wherein at least one acting acceleration is inferred according to a comparison between the detected measurement difference and a threshold value.
